(19) United States
(12) Patent Application Publication
(10) Pub. No.: US 2025/0367621 A1
(43) Pub. Date: Dec. 4, 2025

(54) AUTOCLAVE REACTION DEVICE AND RELATED METHODS

(71) Applicant: Urbix, Inc., Mesa, AZ (US)

(72) Inventors: Palash GANGOPADHYAY, Chapel Hill, NC (US); Jillian GRASS, Phoenix, AZ (US); Jan SEGURA SCHREIBER, Hamburg (DE); Jorge Alberto GARCIA RAMIREZ, Mesa, AZ (US)

(21) Appl. No.: 18/679,753

(22) Filed: May 31, 2024

(51) Int. Cl. B01J 3/04; B01J 3/00; B01J 3/02; B01J 19/00; B01J 19/24

(52) U.S. Cl. CPC B01J 3/04; B01J 3/002; B01J 3/02; B01J 19/0013; B01J 19/2415; B01J 2203/061; B01J 2219/00083; B01J 2219/00162; B01J 2219/00166

(57) ABSTRACT

An autoclave reactor for facilitating a reaction, the autoclave reactor including: an elongated reaction chamber; a slurry inlet in fluid communication with the elongated reaction chamber and having a slurry inlet valve that is configured to supply a slurry; a reactant inlet in fluid communication with the elongated reaction chamber and having a reactant inlet valve that is configured to supply at least one reactant to the elongated reaction chamber; a compressed gas inlet in fluid communication with the elongated reaction chamber and having a compressed gas inlet valve that is configured to supply a compressed gas to the elongated reaction chamber; a pump in fluid communication with the elongated reaction chamber and configured to agitate the slurry and at least one reactant in the elongated reaction chamber; and a heating element configured to heat the slurry and the at least one reactant in the elongated reaction chamber.

### TECHNICAL FIELD

The present invention relates to an autoclave reaction device and related methods.

### BACKGROUND

An autoclave is a device used to carry out a process in a high temperature and high pressure environment. Autoclaves may be used for a range of functions, including to carry out a high temperature and high pressure reaction. Autoclaves may also be used to sterilize equipment or to cure chemical coatings or to vulcanize rubber.

An autoclave for carrying out a process or reaction is typically a chamber that can be sealed and a mechanism for heating the chamber and/or increasing the pressure of the chamber. For example, an autoclave device may have a pressure seal and a heating element. If a liquid is present in the autoclave device and is heated, the liquid becomes a gas and elevates the pressure of the autoclave device. Autoclave devices typically also include pressure release valve for reducing or regulating the pressure in the device.

### SUMMARY

According to some embodiments of the present inventive concept, an autoclave reactor is provided, the autoclave reactor may include: an elongated reaction chamber; a slurry inlet in fluid communication with the elongated reaction chamber and having a slurry inlet valve that is configured to supply a slurry comprising a solid material, a liquid, and at least one salt dissolved in the liquid to the elongated reaction chamber in an open position and to seal the elongated reaction chamber in a closed position; a reactant inlet in fluid communication with the elongated reaction chamber and having a reactant inlet valve that is configured to supply at least one reactant to the elongated reaction chamber in an open position and to seal the elongated reaction chamber in a closed position; a compressed gas inlet in fluid communication with the elongated reaction chamber and having a compressed gas in valve that is configured to supply a compressed gas to the elongated reaction chamber to thereby increase a pressure of the elongated reaction chamber in an open position and to seal the elongated reaction chamber in a closed position; a pump in fluid communication with the elongated reaction chamber and configured to agitate the slurry and at least one reactant in the elongated reaction chamber; and a heating element configured to heat the slurry and the at least one reactant in the elongated reaction chamber.

A method of using an autoclave reactor is provided. the method may include: supplying a slurry to an elongated reaction chamber via a slurry inlet, the slurry comprising a solid material, a liquid, and at least one salt dissolved in the liquid; supplying at least one reactant to the elongated reaction chamber; supplying a compressed gas to the elongated reaction chamber having the slurry and the at least one reactant therein to thereby increase a pressure of the elongated reaction chamber; heating the elongated reaction chamber having the slurry and the at least one reactant therein to thereby conduct a reaction at increased temperature and pressure.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a perspective view of a loop autoclave device according to some embodiments.

FIG. 2 is a perspective view of a serpentine loop autoclave device according to some embodiments.

FIG. 3 is a flowchart according to some embodiments.

FIG. 4 is an example of a graph of the pressure times the temperatures (PT Value) over time in an autoclave device according to some embodiments.

### DETAILED DESCRIPTION

Prior processing and purification equipment and related methods, such as batch processing equipment, may experience problems with corrosion and long heating times. This equipment may include agitators or stirrers to facilitate reactions; however, agitators and stirrers add complexity to the system and are additional components that may corrode due to the use of acidic reagents and other chemicals.

In addition, reactions that take place in batch processing equipment may take a long time to perform, such as hours, which increases the exposure time of the equipment to corrosive reagents and other chemicals. Large batch processing equipment can be used at elevated temperatures; however, the time to bring the contents of the equipment up to temperature may be long. Reagents and other chemicals may not be good for the environment, and disposal of these materials is another significant issue in current systems.

According to some embodiments, an autoclave reactor is provided that facilitates a high pressure and/or high temperature environment for a reaction (e.g., a chemical reaction, such as a leaching reaction, a purification reaction, and/or the like). In some embodiments, the autoclave reactor is configured to agitate the reaction components by circulating the reaction components through the autoclave reactor at high temperatures and high pressure to facilitate the speed and efficiency of the reaction. Accordingly, a separate agitator or stirrer may be omitted, which can simplify the equipment and reduce the number of components subjected to corrosive materials. In particular embodiments, reactions may be performed more quickly than conventional reactors, which reduces the amount of time that the equipment is exposed to harsh reactants and other chemicals, therefore reducing corrosion. Moreover, reagents and other chemicals may be re-used by recirculating them to a filtration tank to remove solids or impurities so that the reagents and other chemicals may be used in subsequent reactions. In some embodiments, more than 60% of the reagents may be reused.

Although various types of reactions may be performed in the autoclave reactors described herein, in some embodiments, the autoclave reactors may be used to facilitate a purification reaction in which a slurry is introduced to a reaction chamber together with various reaction components, such as one or more acids. The slurry may include a solid component or material (e.g., a metal, a mineral, and/or the like) to be purified by way of separating impurities from the solid component during the purification reaction involving the one or more acids. That is, as an example, the autoclave devices described herein may facilitate the purification reaction to separate impurities from the solid components by way of causing the impurities to take on a liquid state. In this way, liquified impurities may be separated, isolated, and removed from the solid components. Once the purification reaction has occurred at an elevated temperature and/or pressure in the autoclave reactor, the slurry may be removed from the autoclave device and the components of the slurry may be further processed or purified. An elevated temperature includes temperatures above room temperature and an elevated pressure includes pressures above atmospheric pressure. For example, in some embodiments, the solid components of the slurry may be subsequently rinsed and/or filtered to remove the liquid and, thus, the liquid impurities that were separated from the solid components during the purification reaction. In this way, a metal (e.g., Au, Ag, Sn, Cu, etc.) or a mineral (e.g., graphite, rare earths, etc.) may be purified to a grade or level that is greater than 99%. In addition, the reagents may be recirculated, reducing environmental impact of the use of the reagents and other chemicals.

As used herein, the term “reaction chamber” includes the portions of the reactor in which the reaction occurs. In some embodiments, the reaction chamber may include one or more conduits, such as pipes, and/or a series of conduits, such as pipes. that are connected by connectors, in which the reaction occurs. As described herein, in some embodiments, the reaction chamber may vary in length from about 10 fee to about 200 feet and may include a volume of at least about 80 L or more.

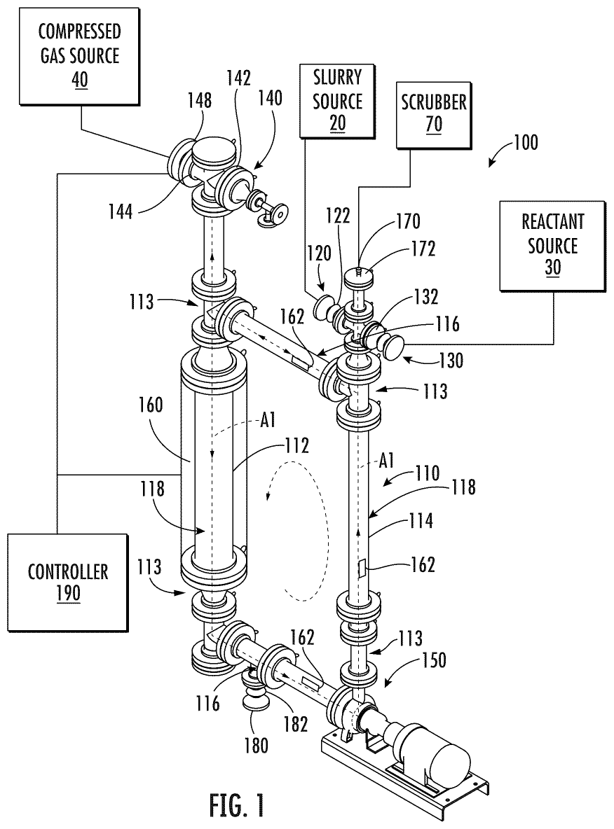

As illustrated in FIG. 1, an autoclave reactor 100 for facilitating a reaction at an elevated temperature and/or pressure is shown. The autoclave reactor 100 includes an elongated reaction chamber 110, a slurry inlet 120, a reactant inlet 130, a compressed gas inlet 140, a pump 150, a heating element 160, a scrubber outlet 170, a slurry outlet 180, and a controller 190.

The slurry inlet 120 is in fluid communication with the reaction chamber 110 and has a slurry inlet valve 122 that is configured to supply a slurry to the reaction chamber 110 of the autoclave reactor 100. The slurry inlet valve 122 supplies the slurry to the reaction chamber 110 in an open position and seals the reaction chamber 110 in a closed position. The slurry inlet 120 may be connected to a slurry source 20 (e.g., a container, tank, supply line, and/or the like). In some embodiments, the slurry may include a solid material, a liquid, and at least one salt dissolved in the liquid.

The reactant inlet 130 is in fluid communication with the reaction chamber 110 and may provide a reactant from a reactant source 30. The reactant inlet 130 includes a reactant inlet valve 132 that has an open position and a closed position such that the reactant inlet valve 132 supplies one or more reactants to the reaction chamber 110 in an open position and seals the reaction chamber 110 in a closed position. In some embodiments, more than one reactant may be provided to the reactant inlet 130 or multiple reactant inlets may be provided for different reactants. In some embodiments, the reactant(s) include acids for a chemical reaction. A reactant source(s) 30 (e.g., container(s), tank(s), supply line(s), etc.) may be connected to the reactant inlet 130 for providing the reactants to the reaction chamber 110.

The compressed gas inlet 140 is in fluid communication with the reaction chamber 110. The compressed gas inlet 140 has a compressed gas inlet valve 142 that is configured to supply a compressed gas from a gas source 40 (e.g., a supply line, a tank, etc.) to the reaction chamber 110 in an open position and to seal the reaction chamber 110 in a closed position. In some embodiments, the compressed gas inlet 140 supplies a compressed gas to the reaction chamber 110 to thereby increase a pressure of the reaction chamber 110 during a reaction.

The heating element 160 is configured to heat the slurry and the reactant(s) in the elongated reaction chamber 110. The heating element 160 may include one or more of thermal coil(s), a heater. a thermal blanket, a thermal jacket, and/or the like, that may be wrapped around at least a portion of the elongated reaction chamber 110. However, any suitable heating element may be used, including thermoelectric devices. In some embodiments, one or more of the slurry. reactants, or compressed air are heated prior to being input to the reaction chamber 110. Accordingly, external heating elements may be provided and connected to the slurry source 20, the reactant source 30, and/or the compressed gas source 40.

The reaction chamber 110 may include one or more pressure sensor(s) 144 configured to detect a pressure in the reaction chamber 110 and one or more temperature sensor(s) 162 configured to detect a temperature in the reaction chamber 110 or of the slurry in the reaction chamber 110. The respective pressure and temperature sensor(s) 144 and 162 may be positioned in an interior of the reaction chamber 110 or on an exterior surface of the reaction chamber 110. In some embodiments, multiple pressure sensors 144 and multiple temperature sensors 162 may be provided at different locations (interior or exterior locations) to obtain measurements and monitor pressure and temperature at different points or locations in the reaction chamber 110. The reaction chamber 110 may be configured to maintain a pressure and/or a temperature such that a value of a pressure multiplied by a temperature (PT) meets or exceeds a predetermined value, such as a value equal to or greater than 100 MPa° C. or equal to or greater than 150 MPa° C. For example, the controller 190 is in communication with the pressure sensor(s) 144 and the temperature sensor(s) 162. The pressure and temperature of the reaction chamber 110 may be controlled manually by an operator, or the controller 190 may control the amount of compressed air from the compressed gas source 40 and/or the temperature of the chamber 110 by controlling the gas inlet valve 142, the pressure release valve 148, and/or the heating element 160. In some embodiments, the controller 190 may control the elements of the autoclave reactor 100 after the slurry and reactants have entered the reaction chamber 110 to obtain a desired pressure and temperature required for a specific reaction, and in particular embodiments, the controller 190 may control the autoclave reactor 100 to achieve a desired pressure×temperature value (i.e., a PT value). The controller 190 may monitor the PT value and control the pressure valve and heating element to increase a PT value to at least 150 MPa° C. in the elongated reaction chamber, e.g., so that the PT value is maintained above 100 MPa° C. for at least 5 or 10 or 20 minutes or more. Reactions times of less than two hours, less than an hour and a half or less than one hour may also be accommodated. However, the reaction times and/or PT values are not limited thereto. In some embodiments, the pressure release valve 148 may be used to keep the internal pressure of the reaction chamber 110 below a set pressure, for example, for safety reasons.

The pump 150 is in fluid communication with the reaction chamber and is configured to agitate the slurry and the reactant(s) in the elongated reaction chamber. The pump may agitate the slurry and the reactant(s) by circulating the slurry through the reaction chamber.

The reaction chamber 110 may form a loop along arrow Al such that the slurry and the reactant(s) are pumped through the loop to circulate through a flow path around the loop in the direction of arrow A1. In some embodiments, the reaction chamber 110 is configured in a curved or serpentine shape (e.g., having at least one bend or curve in the elongated chamber 110) such that circulation through the reaction chamber 110 by the pump 150 further agitates the slurry and reactant(s) mixture. The pump 150 may be a pump suitable for high pressure and high temperature environments, such as an explosive atmospheres (ATEX) certified pump. The pump 150 may have a flow rate of 102 m³/h (450 gpm) or more and operate at a pressure up to 17 bar (250 psi) and at a temperature from −29° C. to 121° C. In this configuration, when the slurry and reactants are added to the reaction chamber 110, the pump 150 circulates the contents of the reaction chamber 110 along a flow path indicated by arrow A1. In some embodiments, this circulation flow path may increase agitation in the chamber 110 without requiring a separate agitator or stirrer. For example, the slurry, reactant, and/or vapor may circulate through the reaction chamber more than once, more than 10 times, or more than 100 times. The circulation of the slurry, reactant, and or vapor in the chamber 110 may be continuous or intermittent and may occur for a portion of the reaction time or for the entire reaction time, such as greater than five or ten minutes or twenty minutes or more. In some embodiments, the circulation of the slurry may occur for an hour, an hour and a half, or up to two hours.

The scrubber outlet 170 has a scrubber outlet valve 172 that is configured to output gas from the reaction chamber 110 when the scrubber outlet valve 172 is in an open position. In some embodiments, the gas output from the elongated reaction chamber includes acidic vapors and the scrubber outlet 170 is connected to a scrubber 70 in that is configured to neutralize the acidic vapors.

After a process such as a reaction occurs, the slurry may exit the reaction chamber 110 via the slurry outlet 180, which includes an outlet valve 182 for opening the slurry outlet 180. In some embodiments, additional processing steps may be performed, such as rinsing or filtering, to further process the slurry. For example, the solid component(s) of the slurry may be separated from the liquid components of the slurry and/or additional filtering or rinsing steps may be performed. In this way, liquified impurities may be rinsed and filtered from the solid components so that the solid components are equal to or greater than 99% pure (e.g., 99.5% pure).

As illustrated, the elongated reaction chamber 110 may include one or more pipes configured such that, when the slurry inlet valve 122 and the reactant inlet valve 132 are in a closed position, the pipe(s) forms a closed flow pathway or loop, and the reaction chamber 110 may be sealed to provide a high temperature and high-pressure environment. As illustrated, the pipes of the reaction chamber 110 include fluidly connected vertical pipes 116 and horizontal pipes 118 connected by connectors 113 in a rectangular loop configuration. However, any suitable conduit or chamber may be used to form the closed flow pathway of the reaction chamber 110, as indicated by arrow A1. In some embodiments, the pipe(s) may have a diameter of between about 1 and 15 inches, or about 4 and 8 inches. The pipe configuration, including the pipe diameter, length, and flow pathway (e.g., a combination of curves, bends, and/or straight portions), may be selected to agitate the slurry as the slurry and a vapor is circulated through the reaction chamber 110 by the pump 150. In some embodiments, the pipe or conduit may have different cross-sectional shapes or sizes, which may further mix the contents of the reaction chamber 110 such as the slurry, the vapor, and the reactants to facilitate a reaction. For example, as illustrated in FIG. 1, the reaction chamber 110 includes a larger portion 112 and a smaller portion 114. As the slurry is circulated between different diameter pipes, the slurry and reactant(s) are further agitated. For example, the larger portion 112 may be about eight inches in diameter and the smaller portion 114 may have a diameter that is about half as much, or four inches in diameter. In addition, the pump 150 may pump the slurry out of the reaction chamber 110 and acidic vapors to the scrubber 70 when the reaction is finished.

In some embodiments, the conduit or pipe of the reaction chamber 110 may be formed of a corrosive resistant and heat tolerant material, such as stainless steel, hastelloy, tungsten, and/or the like. The interior of the reaction chamber 110 may optionally include a liner or coating configured to provide additional durability and/or corrosive resistance. For example, the interior of the reaction chamber 110 may include acrylonitrile butadiene styrene (ABS), acetal homopolymers. acrylic thermoplastic, cellulose acetate butyrate (CAB), chlorinated polyvinyl chloride (CPVC). ethylene chlorotrifluoroethylene (ECTFE), high density polyethylene (HDPE), polyetherether ketone (PEEK), polyethylene terephthalate (PET), polycarbonate, polypropylene, polysulfone, polyphenylene sulfide (PPS), polyvinyl chloride (PVC), polyvinylidene fluoride (PVDF), polytetrafluoroethylene (PTFE), and ultra-high molecular weight polyethylene (UHMW), although embodiments according to the present invention are not limited thereto.

The reaction chamber may have a size and shape configured for desired parameters of a reaction. In some embodiments, the reaction chamber has a volume of at least about 80 L, at least about 1000 L, or between 100 L and 1300 L. Volumes of 1500 L or greater may be used, depending on the desired volume and reaction parameters. The total length of the pipe(s) or reaction chamber 110 may be at least about 10 feet to about 200 feet. In specific embodiments, the length of the reaction chamber may be about 30 feet or about 130 feet.

Although it should be understood that the autoclave reactor 100 may be used for any suitable reaction, in some embodiments, the reactant(s) include one or more acids, and the solid material of the slurry is a material for which a purification reaction is desired. For example, the solid material of the slurry may be graphite, precious metals, or rare earth metals; however, embodiments of the current invention are not limited thereto.

As illustrated in FIG. 1, the loop formed by the pipe/reaction chamber 110 may be in a generally rectangular or square shape. However, any suitable shape may be used. The loop may be a circular or serpentine shape. In some embodiments, a serpentine shaped elongated reaction chamber or other shape with at least one curved or bent portion(s) (e.g., curved or bent connectors) may increase agitation of the slurry as the pump 150 circulates and continues to re-circulate the slurry through the reaction chamber 110.

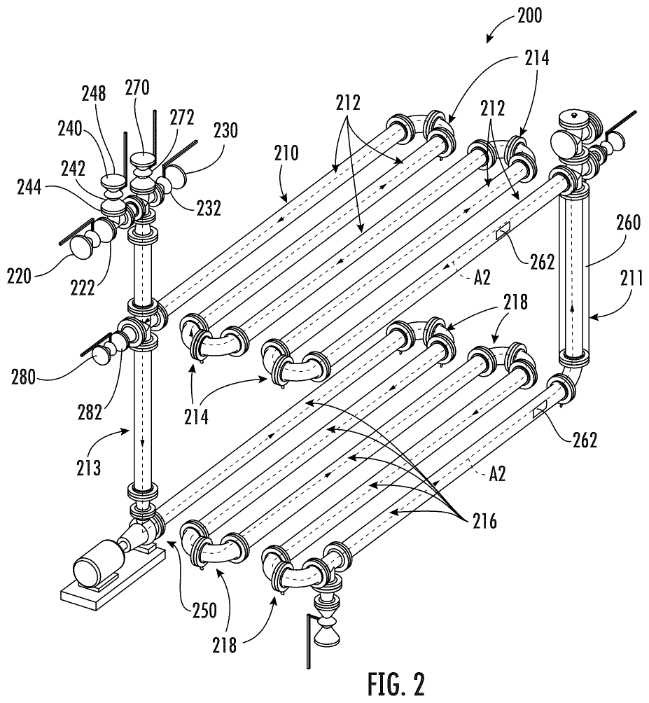

For example, as illustrated in FIG. 2, an autoclave reactor 200 for facilitating a reaction at an elevated temperature and pressure includes an elongated reaction chamber 210 having a serpentine loop shape as indicated by arrow A2. The autoclave reactor 200 includes analogous components to those describe with respect of FIG. 1, such as a slurry inlet 220 with a slurry inlet valve 222, a reactant inlet 230 with a reactant inlet valve 232, a compressed gas inlet 240, a pump 250, a heating element 260 and a temperature sensor 262, a scrubber outlet 270 with a scrubber outlet valve 272, and a slurry outlet 280 with a slurry outlet valve 282. The autoclave reactor 200 may include a gas inlet valve 242, a pressure sensor 244, and a pressure relief valve 248. The autoclave reactor 200 may be connected to additional components, such as those described with respect to FIG. 1 (e.g., the slurry source 20, the reactant source 30, the compressed gas source 40, the scrubber 70 and the controller 190).

As illustrated, the reaction chamber 210 is in a serpentine loop shape including one or more curved portions. The reaction chamber 210 may include upper horizontal conduits or pipes 212 connected by connectors 214 and lower horizontal conduits or pipes 216 connected by connectors 218. The upper horizontal pipes 212 are connected to the lower horizontal pipes 216 by vertical conduits or pipes 211, 213. Accordingly, the reaction chamber 210 includes an upper section of parallel pipes 212 in an upper plane, which together with the connectors 214 form a serpentine or snake-like shape having a plurality of curves. The horizontal pipes 211, 213 connect the upper section of parallel pipes 212 to a lower section of parallel pipes 216 in a lower plane, which together with the connectors 218 form a lower serpentine or snake-like shape. Each of the pipes 212, 216 may be about 20 feet long and the pipes 211, 213 may be about 10 feet long, and the pipes 211, 212, 213 216, may have a diameter of about 8 inches.

In this configuration, the loop shaped flow path as indicated by arrow A2 may provide additional curves in the curved or serpentine flow path that agitates the slurry, reactants, and vapor in the reaction chamber 210. Accordingly, additional stirrers or agitators may not be needed, and/or the reaction times may be reduced. Moreover, larger volumes of slurry, reactants, and vapor may be accommodated, such as up to 1000 L or 1300 L or more. For example, the slurry, reactant, and/or vapor may circulate through the reaction chamber more than once, more than 10 times, or more than 100 times. The circulation and reaction times may be similar to those discussed above with respect to FIG. 1. For example, the circulation of the slurry, reactant, and or vapor in the chamber 210 may be continuous or intermittent and may occur for a portion of the reaction time or for the entire reaction time, such as greater than five or ten minutes or twenty minutes or more. In some embodiments, the circulation of the slurry may occur for an hour, an hour and a half, or up to two hours.

Although the configuration of FIG. 2 is illustrated with respect to the reaction chamber 210 having upper parallel pipes 212 with upper connectors 214, lower parallel pipes 216 with upper connectors 218, and horizontal pipes 211, 213 connecting the pipes 212, 216, any suitable loop shape may be used. For example, a single plane of parallel pipes may be used, or more or fewer pipe sections/connectors may be proved, depending on the parameters of the reaction, such as the volume, time duration or desired degree of agitation of the reaction.

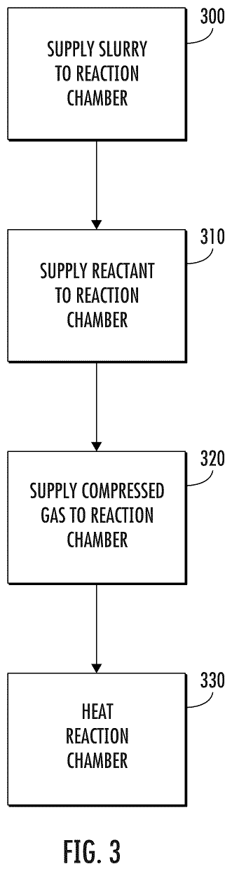

As illustrated in FIG. 3, a method of using an autoclave reactor to facilitate a reaction at an elevated temperature and pressure. The method 300 may include supplying a slurry to an elongated reaction chamber via a slurry inlet (Block 300). As described herein, the slurry may include a solid material, a liquid, and at least one salt dissolved in the liquid. At least one reactant is supplied the elongated reaction chamber 110, 210 (Block 310). A compressed gas is supplied to the elongated reaction chamber 110, 210 having the slurry and the reactant therein to thereby increase a pressure of the elongated reaction chamber 110, 210 (Block 320). The reaction chamber 110, 210 having the slurry and the at least one reactant therein may be heated by an optional heating element and/or the reactants and/or slurry may be heated before entering the reaction chamber 110, 210 to thereby conduct a reaction at increased temperature and pressure (Block 330). The slurry and reactant may additionally be agitated (e.g., via circulating and re-circulating through a series or system of pipes) for a desired amount of time.

In some embodiments, after the reaction is performed for a first time period, a reaction byproduct gas is output from the reaction chamber 110, 210. For example, the reaction byproduct gas may be output from the scrubber outlet 170, 270 and neutralized by the scrubber 70. The reaction byproduct gas may include acidic vapors produced during the reaction in the reaction chamber 110, 210.

After the reaction is performed and the slurry and reactant circulate for the first time period or a second time period, the liquid of the slurry may include impurities that have been removed from the solid material of the slurry. Accordingly, when the slurry is removed from the reaction chamber 110, 210, the slurry may be further processed, for example, by filtering or washing the impurities from the slurry to provide a solid material having increased purity (e.g., ≥90% pure, ≥99.5% pure, 99.9% pure, etc.) compared to the solid material contained in the slurry initially, before entering the autoclave reactor. The time period for the reaction may be less than 20 minutes or less than 10 minutes; however, embodiments according to the present invention are not limited thereto. Moreover, reagents and other chemicals may be re-used by recirculating them to a filtration tank to remove solids or impurities so that the reagents and other chemicals may be used in subsequent reactions. In some embodiments, more than 60% of the reagents may be reused.

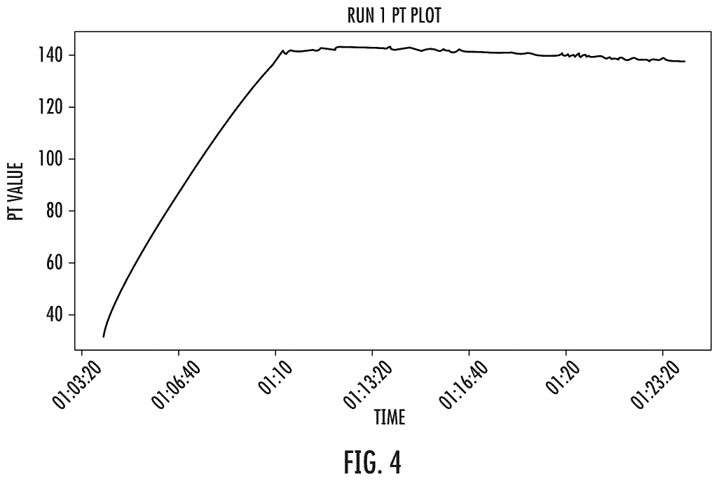

As illustrated in FIG. 4, the reaction chamber 110 of FIG. 1 was operated by supplying a slurry to the reaction chamber, supplying the reactant(s) to the reaction chamber, supplying a compressed gas to the reaction chamber, and heating the reaction chamber. As illustrated in FIG. 4, the reaction chamber 110 had a PT value at or close to 140 MPa° C. and did not go below a PT value of 130 MPa° C. for at least 12-13 minutes. Without wishing to be bound by any particular theory, it may be advantageous to maintain a PT value above 100 MPa° C. for more than 10 minutes or more than 20 minutes for adequately ensuring that a reaction has taken place. Accordingly, the PT value may be higher than 100 MPa° C. at the beginning of the reaction time, e.g., 140 MPa° C., to maintain the PT value higher than 100 MPa° C. for the duration of the reaction.

In some embodiments, an autoclave reactor for facilitating a reaction includes an elongated reaction chamber; a slurry inlet in fluid communication with the elongated reaction chamber and having a slurry inlet valve that is configured to supply a slurry comprising a solid material, a liquid, and at least one salt dissolved in the liquid to the elongated reaction chamber in an open position and to seal the elongated reaction chamber in a closed position; a reactant inlet in fluid communication with the elongated reaction chamber and having a reactant inlet valve that is configured to supply at least one reactant to the elongated reaction chamber in an open position and to seal the elongated reaction chamber in a closed position; a compressed gas inlet in fluid communication with the elongated reaction chamber and having a compressed gas inlet valve that is configured to supply a compressed gas to the elongated reaction chamber to thereby increase a pressure of the elongated reaction chamber in an open position and to seal the elongated reaction chamber in a closed position; a pump in fluid communication with the elongated reaction chamber and configured to agitate the slurry and the at least one reactant in the elongated reaction chamber; and a heating element configured to beat the slurry and the at least one reactant in the elongated reaction chamber.

The autoclave reactor may further include a scrubber outlet configured to output a gas from the elongated reaction chamber.

The gas output from the elongated reaction chamber may include acidic vapors and the autoclave reactor may further include a scrubber in communication with the scrubber outlet and configured to neutralize the acidic vapors.

The elongated reaction chamber may include a pipe configured such that, when the slurry inlet valve and the reactant inlet valve are in a closed position, the pipe forms a closed flow pathway.

The elongated reaction chamber may include a pressure sensor configured to detect a pressure in the elongated reaction chamber and a temperature sensor configured to detect a temperature in the elongated reaction chamber.

The elongated reaction chamber may be configured to maintain a value of a pressure multiplied by a temperature of over 100 MPa° C.

The heating element may include thermal coils around the elongated reaction chamber.

The elongated reaction chamber may include a serpentine shaped elongated reaction chamber having at least one curved portion.

The autoclave reactor may further include at least one external heating element configured to heat at least one of the slurry and the at least one reactant prior to being received in the elongated reaction chamber.

The elongated reaction chamber may have a volume of at least about 1000 L.

The elongated reaction chamber may include a controller in communication with the pressure sensor and the temperature sensor, the controller being configured to control an air compressor connected to the compressed gas inlet and to control the heating element to increase a pressure multiplied by a temperature to at least 150 MPa° C. in the elongated reaction chamber.

The at least one reactant may include at least one acid.

The solid material of the slurry may include graphite.

In some embodiments, a method of using an autoclave reactor may include supplying a slurry to an elongated reaction chamber via a slurry inlet, the slurry comprising a solid material, a liquid, and at least one salt dissolved in the liquid; supplying at least one reactant to the elongated reaction chamber; supplying a compressed gas to the elongated reaction chamber having the slurry and the at least one reactant therein to thereby increase a pressure of the elongated reaction chamber; and heating the elongated reaction chamber having the slurry and the at least one reactant therein to thereby conduct a reaction at increased temperature and pressure.

The slurry and the at least one reactant may be agitated in the elongated reaction chamber using a pump in fluid communication with the elongated reaction chamber.

The step of supplying a compressed gas and heating the elongated reaction chamber may be sufficient to increase a value of a pressure multiplied by a temperature to at least 100 MPa° C. in the elongated reaction chamber.

After the reaction is performed for a time period, a reaction byproduct gas may be output from the elongated reaction chamber.

The reaction byproduct gas may include acidic vapors and the method may include neutralizing the acidic vapors before outputting the reaction byproduct gas from the elongated reaction chamber.

After the reaction is performed for a time period, the liquid of the slurry may include impurities separated from the solid material, and the method may include removing the slurry from the elongated reaction chamber and filtering or washing the impurities from the slurry to provide a solid material having increased purity. The time period may be less than 20 minutes or less than 10 minutes.

The present inventive concepts are described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the inventive concepts to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting thereof. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.” The term “about” should be understood to include variations of up to 20%.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it may be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” may encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The foregoing is illustrative of the present inventive concept and is not to be construed as limiting thereof. Although a few example embodiments have been described, those skilled in the art will readily appreciate that many modifications are possible in the exemplary embodiments without materially departing from the novel teachings of this inventive concept. Accordingly, all such modifications are intended to be included within the scope of this inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims.

What is claimed is:

1. An autoclave reactor for facilitating a reaction, the autoclave reactor comprising:
an elongated reaction chamber;
a slurry inlet in fluid communication with the elongated reaction chamber and having a slurry inlet valve that is configured to supply a slurry comprising a solid material, a liquid, and at least one salt dissolved in the liquid to the elongated reaction chamber in an open position and to seal the elongated reaction chamber in a closed position;
a reactant inlet in fluid communication with the elongated reaction chamber and having a reactant inlet valve that is configured to supply at least one reactant to the elongated reaction chamber in an open position and to seal the elongated reaction chamber in a closed position;
a compressed gas inlet in fluid communication with the elongated reaction chamber and having a compressed gas inlet valve that is configured to supply a compressed gas to the elongated reaction chamber to thereby increase a pressure of the elongated reaction chamber in an open position and to seal the elongated reaction chamber in a closed position;
a pump in fluid communication with the elongated reaction chamber and configured to agitate the slurry and the at least one reactant in the elongated reaction chamber; and
a heating element configured to heat the slurry and the at least one reactant in the elongated reaction chamber.

2. The autoclave reactor of claim 1, further comprising a scrubber outlet configured to output a gas from the elongated reaction chamber.

3. The autoclave reactor of claim 2, wherein the gas output from the elongated reaction chamber comprises acidic vapors and further comprising a scrubber in communication with the scrubber outlet and configured to neutralize the acidic vapors.

4. The autoclave reactor of claim 1, wherein the elongated reaction chamber comprises a pipe configured such that, when the slurry inlet valve and the reactant inlet valve are in a closed position, the pipe forms a closed flow pathway.

5. The autoclave reactor of claim 1, wherein the elongated reaction chamber comprises a pressure sensor configured to detect a pressure in the elongated reaction chamber and a temperature sensor configured to detect a temperature in the elongated reaction chamber.

6. The autoclave reactor of claim 1, wherein the elongated reaction chamber is configured to maintain a value of a pressure multiplied by a temperature of over 100 MPa° C.

7. The autoclave reactor of claim 1, wherein the heating element comprises thermal coils around the elongated reaction chamber.

8. The autoclave reactor of claim 1, wherein the elongated reaction chamber comprises a serpentine shaped elongated reaction chamber having at least one curved portion.

9. The autoclave reactor of claim 1, further comprising at least one external beating element configured to heat at least one of the slurry and the at least one reactant prior to being received in the elongated reaction chamber.

10. The autoclave reactor of claim 1, wherein the elongated reaction chamber has a volume of at least about 1000 L.

11. The autoclave reactor of claim 5, wherein the elongated reaction chamber comprises a controller in communication with the pressure sensor and the temperature sensor, the controller being configured to control an air compressor connected to the compressed gas inlet and to control the heating element to increase a pressure multiplied by a temperature to at least 150 MPa° C. in the elongated reaction chamber.

12. The autoclave reactor of claim 1, wherein the at least one reactant comprises at least one acid.

13. The autoclave reactor of claim 1, wherein the solid material of the slurry comprises graphite.

14. A method of using an autoclave reactor, the method comprising:
supplying a slurry to an elongated reaction chamber via a slurry inlet, the slurry comprising a solid material, a liquid, and at least one salt dissolved in the liquid;
supplying at least one reactant to the elongated reaction chamber;
supplying a compressed gas to the elongated reaction chamber having the slurry and the at least one reactant therein to thereby increase a pressure of the elongated reaction chamber; and
heating the elongated reaction chamber having the slurry and the at least one reactant therein to thereby conduct a reaction at increased temperature and pressure.

15. The method of claim 14. further comprising agitating the slurry and the at least one reactant in the elongated reaction chamber using a pump in fluid communication with the elongated reaction chamber.

16. The method of claim 14, wherein supplying a compressed gas and heating the elongated reaction chamber are sufficient to increase a value of a pressure multiplied by a temperature to at least 100 MPa° C. in the elongated reaction chamber.

17. The method of claim 14, wherein after the reaction is performed for a time period, outputting a reaction byproduct gas from the elongated reaction chamber.

18. The method of claim 17, wherein the reaction byproduct gas comprises acidic vapors and further comprising neutralizing the acidic vapors before outputing the reaction byproduct gas from the elongated reaction chamber.

19. The method of claim 14, wherein after the reaction is performed for a time period, the liquid of the slurry comprises impurities separated from the solid material, wherein the method further comprises removing the slurry from the elongated reaction chamber and filtering or washing the impurities from the slurry to provide a solid material having increased purity.

20. The method of claim 19. wherein the time period is less than 20 minutes or less than 10 minutes.
